(19) United States
(12) Patent Application Publication
(10) Pub. No.: US 2010/0000579 A1
(43) Pub. Date: Jan. 7, 2010

(54) Compositions And Methods For Removing Scale And Inhibiting Formation Thereof

(76) Inventors: Robert S. Reinbold, Kansas City, MO (US); Thomas Charles List, Kearney, MO (US)

Correspondence Address: LATHROP & GAGE LLP, 2345 GRAND Boulevard, SUITE 2400, KANSAS CITY, MO, 64108, US

(21) Appl. No.: 12/496,997

(22) Filed: Jul. 2, 2009

Related U.S. Application Data
(60) Provisional application No. 61/078,190, filed on Jul. 3, 2008.

(51) Int. Cl. B08B 3/08; C02F 5/14

(52) U.S. Cl. 134/34; 252/180

(57) ABSTRACT

Compositions for removing scale and/or inhibiting formation thereof include an alkaline agent, a primary scale inhibitor, a secondary scale inhibitor and a solvent. The primary scale inhibitor may include phosphonic acid, salts of phosphonic acids and combinations thereof. Suitable secondary scale inhibitor may include aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof. The compositions may be prepared as a stable concentrates that have pH values greater than or equal to 11. The compositions may also be prepared on site as a use solution. Methods of using the compositions to extend system operating times and to remove scale from and/or inhibit formation of scale on an article are also disclosed.

### RELATED APPLICATIONS

This application claims priority of U.S. Provisional Application No. 61/078,190 filed Jul. 3, 2008, the content of which is hereby incorporated into this application by reference.

### BACKGROUND

Water typically includes cations, such as calcium, magnesium and barium, and anions, such as carbonate, sulfate and oxalate. At certain combinations of temperature, pH and concentration, these cations and anions can form insoluble salts, e.g., calcium carbonate, that precipitate on surfaces of a system in the form of “scale”. Scale disadvantageously affects various types of systems including, for example, cooling towers in a variety of industries (paper, textiles, chemicals, energy); food processing equipment (evaporators, fermentors); ships, boats and other watercraft; as well as papermaking equipment, boilers, warewashers and household appliances.

The presence of scale increases system operating costs by reducing water flow, expediting corrosion, fostering the growth of bacteria and algae, and acting as an insulating layer that diminishes heat transfer. While all of these factors are deleterious, the problem of inefficient heat transfer is compounded by the fact that scale builds quickly near heated surfaces where concentrations of cations and anions become supersaturated.

Cleaning with strong alkaline solutions is commonly employed to remove soils from hard surfaces. However, alkaline conditions promote the deposition of scale onto the surface, and a subsequent acid cleaning is normally required to remove deposited mineral scale. This acid cleaning step (referred to as “acid wash” in this disclosure) requires a temporary shutdown of equipment.

In an attempt to avoid frequent shutdowns, chelating agents that bind metal ions in a 1:1 ratio have been used to inhibit the formation of scale. However, the use of stoichiometric reagents can become prohibitively expensive in flow-through systems. Another approach to reducing the build-up of scale involves the use of “scale inhibitors” that adsorb to metal ions on the surface of scale. This adsorption disrupts growth of crystalline scale, and allows for use of a sub-stoichiometric ratio of inhibitor molecules to metal ions.

Phosphonates are commonly used as scale inhibitors. However, phosphonates are known to precipitate in the presence of calcium to form insoluble calcium phosphonates, which causes a two-fold problem. First, the precipitated calcium phosphonate is itself a form of scale that adheres to surfaces; second, the precipitated phosphonate is no longer present in solution to prevent the formation of calcium carbonate and other insoluble salts.

The formation of calcium phosphonates is expedited at high pH values. At high pH, phosphonates, such as aminotri (methylenephosphonic acid) (ATMP), become highly deprotonated and develop an affinity to bind multiple cations, which may lead to the formation of large Ca₃(ATMP) complexes and/or inorganic network structures. In addition, an increase in the molar ratio of Ca²⁺ to ATMP effectively reduces pKₐ values via chelation, resulting in an increase in the ability of the ATMP molecule to deprotonate. Thus, a high pH and/or a high concentration of calcium ions in solution may promote precipitation of phosphonate. (R. Pairat, C. Sumeath, F. H. Browning, H. S. Fogler, “Precipitation and Dissolution of Calcium-ATMP Precipitates for the Inhibition of Scale Formation in Porous Media,” Langmuir, v. 13, 1997, pp. 1791-1798; U.S. Pat. No. 7,087,781.)

In an attempt to alleviate problems associated with precipitation of calcium phosphonates, polymeric dispersants that suspend calcium phosphonate particles have been used as secondary scale inhibitors. See, e.g., U.S. Pat. No. 5,023,001. These polymeric dispersants act as physical barriers to prevent extensive particle agglomeration. However, these polymeric materials can be expensive, and may be harmful to the environment. Moreover, the polymeric materials may be difficult to rinse off cleanly from the treated system.

### SUMMARY OF THE INVENTION

The instrumentalities disclosed herein advance the art and overcome the problems outlined above by providing compositions and methods for removing scale and/or inhibiting formation of scale. The disclosed compositions and methods are effective in scale removal at high pH, high calcium concentrations and in the presence of protein, fat and/or carbohydrate.

In an embodiment, compositions for removing scale and/or inhibiting formation thereof include (i) an alkaline agent; (ii) a primary scale inhibitor selected from the group consisting of phosphonic acid, salts of phosphonic acids, phosphonic acid derivatives, and combinations thereof, and (iii) a secondary scale inhibitor selected from the group consisting of aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof. In one preferred embodiment, the secondary scale inhibitor does not contain any phosphonous group. In another preferred embodiment, the compositions may also contain at least one surfactant, such as an alkylether hydroxypropyl sultaine surfactant.

The compositions may be prepared and stored as a stable concentrate having pH values greater than or equal to 11. A use dilution may be prepared by diluting the stable concentrate by 5-100 folds with water, other solvents or solutions, more preferably by 10-50 folds. Alternatively, the compositions may be prepared as a use solution ready to be used and may be prepared on site by dissolving or mixing individual components in water or an aqueous solution. A concentrate is typically more convenient to store and transport due to its smaller volume and weight. In one aspect, the concentration of the alkaline agent in the stable concentrate ranges from 10% to 90% (w/w, dry basis), more preferably from 30% to 60% (w/w, dry basis), more preferably from 35% to 55%, even more preferably from 35% to 45%, and most preferably from 37% to 43% (w/w, dry basis). In another aspect, the concentration of the primary scale inhibitor in the stable concentrate ranges from 0.01% to 5% (w/w, dry basis), and more preferably from 0.05% to 5%, even more preferably from 0.2% to 5%, and most preferably from 0.2% to 2% (w/w, dry basis). In another aspect, the concentration of the secondary scale inhibitor in the stable concentrate ranges from 0.01% to 5% (w/w, dry basis), and more preferably from 0.05% to 5%, even more preferably from 0.2% to 5%, and most preferably from 2% to 5% (w/w, dry basis). The stable concentrate may optionally contain one or more surfactant such as an alkylether hydroxypropyl sultaine surfactant. Preferably, the concentration of the surfactant in the stable concentrate ranges from 0.001% to 5% (w/w, dry basis), more preferably from 0.005% to 2%, even more preferably from 0.01% to 1% (w/w, dry basis), and most preferably around 0.25% (w/w, dry basis).

In another embodiment, methods for removing scale from and/or inhibiting formation of scale on an article are disclosed. The methods include providing a composition containing (i) an alkaline agent; (ii) a primary scale inhibitor selected from the group consisting of phosphonic acid, salts of phosphonic acids, phosphonic acid derivatives, and combinations thereof; and (iii) a secondary scale inhibitor selected from the group consisting of aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof.

In another embodiment, a method for removing scale from an article is disclosed. The method includes contacting the article with a use solution (or use dilution) having a pH greater than or equal to 11, or more preferably greater than or equal to 12. The use solution may be prepared on site by mixing individual ingredients or may be derived from a stable concentrate by dilution. The article is typically an equipment that has been soiled during operation.

In one aspect, the alkaline agent to be used in the disclosed compositions may be selected from the group consisting of sodium hydroxide, potassium hydroxide and ammonium hydroxide. Preferably, the alkaline agent is potassium hydroxide. In another aspect, the concentration of the alkaline agent in the use solution may range from 0.1% to 5% (w/w, dry basis), more preferably from 0.5% to 2.5% (w/w, dry basis), and more preferably, from 1% to 1.8%.

In another aspect, the primary scale inhibitor is selected from the group consisting of aminotri(methylenephosphonic acid) (ATMP), 1-hydroxyethylidine-1,1-diphosphonic acid (HEDP), hexamethylenediamine tetra(methylenephosphonic acid), 2-hydroxyethyliminobis(methylenephosphonic acid), bis(hexamethylene)triamine(pentamethylenephosphonic acid), diethylenetriaminepenta(methylenephosphonic acid), ethylenediamine tetra(methylenephosphonic acid) (EDTMPA), phosphorus acid and salts thereof, and the concentration of the primary scale inhibitor in the use solution may range from 0.01% to 0.5% (w/w, dry basis), and more preferably from 0.02-0.2%, and even more preferably about 0.02-0.05% (w/w, dry basis).

In another aspect, the concentration of the secondary scale inhibitor in the use solution may range from 0.01% to 0.5% (w/w, dry basis), and more preferably from 0.05-0.2%, even more preferably from 0.1% to 0.2% (w/w, dry basis). In another aspect, the concentration of the optional surfactant in the use solution is in the range of from 0.0005% to 0.5%, more preferably from 0.001% to 0.01%, and most preferably from 0.001% to 0.005% (w/w on a dry basis).

In another embodiment, a method for removing scale from an article is disclosed. The methods include contacting equipment with a use solution having a pH greater than or equal to 11. The use solution contains (i) an alkaline agent selected from the group consisting of sodium hydroxide, potassium hydroxide and ammonium hydroxide; (ii) a primary scale inhibitor selected from the group consisting of aminotri(methylenephosphonic acid) (ATMP), 1-hydroxyethylidine-1,1-diphosphonic acid (HEDP) and salts thereof; and (iii) a secondary scale inhibitor selected from the group consisting of ethylenediaminetetraacetic acid (EDTA), N-hydroxyethyl-ethylenediaminetriacetic acid (HEDTA) and salts thereof. In another aspect of this disclosure, the composition may contain potassium hydroxide, aminotri(methylenephosphonic acid) (ATMP) and salts thereof, ethylenediaminetetraacetic acid (EDTA) and salts thereof. In yet another aspect, the use solution contains potassium hydroxide, 1-hydroxyethylidine-1,1-diphosphonic acid (HEDP) and salts thereof, and N-hydroxyethyl-ethylenediaminetriacetic acid (HEDTA) and salts thereof.

For purpose of this disclosure, the article to be cleaned may be an isolated piece of equipment or a processing system containing multiple equipments and pipings and/or tubings connecting the equipments. Scale may have already formed on the external or internal surface of the article before application of the disclosed compositions, alternatively the disclosed compositions may be used to prevent formation of scale. In one aspect, the disclosed compositions are suitable for cleaning scale that contains at least one milk protein.

In another embodiment, a method for extending the operating time of a system may include cleaning the system with a use dilution derived from a stable concentrate having a pH greater than or equal to 11. The stable concentrate contains an alkaline agent, a primary scale inhibitor, a secondary scale inhibitor and a solvent, rinsing the system and operating the system. The primary scale inhibitor may be selected from phosphonic acid, salts of phosphonic acids and combinations thereof. The secondary scale inhibitor may be selected from aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof.

After having been treated with the presently disclosed compositions, the system may then be rinsed before being put back into operation. The three steps, namely, cleaning, rinsing and operating, may be repeated at least twice without the need to wash the system with an acid (acid wash), thus helping extending the operation time of the system. In another aspect, the steps of cleaning, rinsing and operating may be repeated between two and five times without performing an acid wash step.

### DETAILED DESCRIPTION

There will now be shown and described compositions and methods for removing scale and/or inhibiting formation thereof. In particular, it has been found that compositions containing an alkaline agent in combination with a phosphonic acid/salt and one or more of an aminocarboxylic acid/salt, carboxylic acid/salt, polycarboxylic acid/salt, gluconic acid/salt, steroid, tetrapyrrol, ionophore, 2,2′-bipyridine, dimercaptopropanol and/or ortho-phenanthroline provide superior detergency and an ability to clean and condition stainless steel so that subsequent accumulation of scale is inhibited.

The present compositions may be prepared and/or sold in concentrated liquid or solid forms, i.e., as a concentrate that can be dissolved or dispersed in a solvent to form a reconstituted solution, typically referred to in the industry as a “use dilution” or “use dilution.”

As used herein, a “stable concentrate” is a homogeneous solution or dispersion that maintains at least 90% of its maximum efficacy for at least thirty days, preferably for at least sixty days and more preferably for at least ninety days when stored at a temperature ranging between 10-30° C., more preferably between 5-40° C., most preferably between 4-50° C. The components of a stable concentrate generally do not degrade, decompose, denature, separate or otherwise rearrange to cause a significant reduction in the ability of a use dilution of the stable concentrate to remove scale or inhibit formation thereof. Generally, stable concentrates contain at least one solvent, such as water or other solvents. For example, propylene glycol, ethylene glycol, glycerine and alcohols may be used as solvents either alone or in combination with water and/or one another.

The present compositions may contain one or more alkaline agent, and the concentration of said alkaline agent in the use solution may range from 0.1% to 5% (w/w, dry basis), more preferably, 0.5% to 2.5%, and even more preferably 1% to 1.8%. The alkaline agent may be selected from the group consisting of alkali metal hydroxides, such as sodium hydroxide, potassium hydroxide, ammonium hydroxide and mixtures thereof.

In an embodiment, potassium hydroxide and ammonium hydroxide are preferred alkaline agents due to regulations limiting the amount of sodium in waste effluent. In general, the use solution contains less than about 2.5% w/w sodium, typically less than about 2% w/w sodium, more typically less than about 1.5% w/w sodium and most typically less than about 1% w/w sodium on a dry basis.

In another embodiment, potassium hydroxide is the preferred alkaline agent because saponification of fats with potassium hydroxide produces soft or liquid soaps that may be easier to remove than hard soaps produced by the reaction of sodium hydroxide and fat.

The present compositions may also include a primary scale inhibitor selected from phosphonic acids and salts thereof. The primary scale inhibitor is typically present in the use solution in a range between 0.01% to 0.5% (w/w, dry basis), more preferably about 0.02-0.2%, and even more preferably about 0.02-0.05% (w/w, dry basis). Exemplary phosphonic acids include aminotri(methylenephosphonic acid) (ATMP), 1-hydroxyethylidine-1,1-diphosphonic acid, hexamethylenediamine tetra(methylenephosphonic acid), 2-hydroxyethyliminobis(methylenephosphonic acid), bis(hexamethylene)triamine(pentamethylenephosphonic acid), diethylenetriaminepenta(methylenephosphonic acid), ethylenediamine tetra(methylenephosphonic acid) (EDTMPA) and phosphorus acid.

The present compositions may also include a secondary scale inhibitor selected from aminocarboxylic acids, carboxylic acids, polycarboxylic acids, gluconic acids and salts thereof. The secondary scale inhibitor is typically present in the use solution in a range between 0.01% and 0.5% (w/w, dry basis), more preferably 0.05% to 0.2%, and even more preferably from 0.1% to 0.2% (w/w, dry basis).

Exemplary aminocarboxylic acids/salts include ethylenediaminetetraacetic acid (EDTA), nitrilotriacetic acid (NTA), diethylenetriaminepentaacetic acid (DTPA), N-hydroxyethyl-ethylenediaminetriacetic acid (HEDTA), ethylenediamine disuccinic acid (EDDS), iminodisuccinic acid (IDS), methylglycinediacetic acid (MGDA), β-alaninediacetic acid (β-ADA), N-hydroxyethyliminodiacetic acid, ethylenedioxydiethylenedinitrilotetraacetic acid, ethylene glycol-bis(2-aminoethyl)-N,N,N′,N′-tetraacetic acid (EGTA), triethanolamine (TEA), ferrioxamines and N,N-bis(carboxylatomethyl)-L-glutamic acid.

Exemplary carboxylic acids/salts and polycarboxylic acids/salts include citric acid, gluconic acid, glycolic acid, salicylic acid, malic acid, malonic acid, fumaric acid, oxaloacetic acid, alpha-ketoglutaric acid, amino acids such as histidine, alanine, glycine, phenylalanine, tryptophan, serine, leucine, lysine, valine, threonine, isoleucine, methionine, arginine, cysteine, glutamine, tyrosine and combinations thereof. A secondary scale inhibitor having at least one acid functionality may be fully or partially deprotonated and used as the corresponding salt.

Additional secondary scale inhibitors may include, for example, steroids, tetrapyrrols, ionophores such as gramicidin and monensin, 2,2′-bipyridine, dimercaptopropanol, ortho-phenanthroline and combinations thereof.

In an embodiment, aminocarboxylic acids/salts, and particularly biodegradable aminocarboxylic acids/salts, are preferred. For example, iminodisuccinic acid (IDS), nitrilotriacetic acid (NTA), methylglycinediacetic acid (MGDA) and the (S, S) stereoisomer of ethylenediamine disuccinic acid (EDDS) are biodegradable.

In an embodiment, fully neutralized salts of the phosphonic acid, aminocarboxylic acid, carboxylic acid, polycarboxylic acid and/or gluconic acid are used to avoid generating heat when an acid reacts with an alkaline agent.

In another embodiment, the secondary scale inhibitors of the present compositions are not polymeric; Rather, they are discrete, non-repeating molecules. Without being limited by theory, there are several possible mechanisms by which the non-polymeric secondary scale inhibitors of the present compositions may prevent or inhibit formation of metal phosphonates. For example, the secondary scale inhibitor may bind to a metal ion that is also bound to a primary scale inhibitor, thereby limiting particle agglomeration and preventing formation of a phosphonate network structure. In particular, secondary scale inhibitors that form 1:1 complexes with metal ions may be used to inhibit the formation of two- and/or three-dimensional metal phosphonate complexes.

According to another possible mechanism, the secondary scale inhibitor may have a higher affinity for one or more metal ions than the primary scale inhibitor. Thus, metal ions that dissociate from the primary scale inhibitor may become “sequestered” by the secondary scale inhibitor so that they do not interfere with the scale inhibiting action of the primary scale inhibitor.

The present compositions, including an alkaline agent, a primary scale inhibitor and a secondary scale inhibitor, and other ingredients, such as surfactants, may be dissolved in or diluted with a solvent, such as water, to make a solution or dispersion referred to as stable concentrate. A use dilution or a use solution may be prepared by diluting the concentrate using water or other appropriate solvent or solutions. The present compositions may also be prepared as a “use dilution” or a “use solution.”

Unless otherwise specified, the concentrations of various ingredients, namely, the alkaline agent, the primary or secondary scale inhibitors, etc, generally refer to the concentrations of these ingredients in the use dilution to be applied to the article or system to be cleaned. The concentrations of these ingredients in the stable concentrate are expected to be higher than the respective concentration in the use dilution. In a preferred embodiment, the compositions of the present disclosure may be prepared as a concentrate with proper ratios between the concentrations of different ingredients such that when the concentrate is diluted, the concentrations of the different ingredients fall with the disclosed concentration range of these ingredients.

Many chemicals are commercially available as a stock solution with certain concentration, e.g., m %. Some chemicals are available only with certain purity, e.g., n % solids. For purpose of this disclosure, the concentration of each individual ingredients is defined as a concentration (w/w) on a dry basis unless otherwise specified. By way of example, a stable concentrate may be prepared using ingredient Y, if the stock solution of ingredient Y has a solid concentration of a % (w/w), and only b % (w/w) of the solid is pure Y, then the concentration of Y in the stable concentrate is a %×b %. If the stable concentrate is diluted to make a c % (w/w) use dilution, i.e., the stable concentrate is diluted by d fold, wherein d=100/c, then the concentration of Y in the final use solution is: a %×b %×c % (w/w on a dry basis).

Table 1 illustrates how the final concentration of each ingredient on a dry basis may be calculated using the composition of E1 as an example.

TABLE 1
Calculation of the Concentrations of Individual Ingredients in a Use
Solution

| | % in original | % solids in | 3.9% solution on wet | Final Conc. (%) dry |
|---|---|---|---|---|
| Component | formula | component | basis | basis |
| KOH | 88.75 | 45 | 0.8875 × 3.9 = 3.46 | 3.46 × .45 = 1.56 |
| ATMP | 2 | 40 | 0.02 × 3.9 = .078 | 0.078 × .40 = 0.031 |
| EDTA | 9 | 39 | 0.09 × 3.9 = 0.351 | 0.351 × .39 = 0.137 |
| Mirataine | 0.25 | 100 | 0.0025 × 3.9 = 0.001 | 0.001 |

To vary the concentration of an individual ingredient, the amount of that ingredient to be added may be varied by using different amount of the stock solution or by varying the concentration of the stock solution. For instance, to make a cleaner with final concentration of Mirataine at 0.005% (w/w dry basis) instead of 0.001% as shown in Table 1, 19.5 g, rather than 3.9 g of the stock Mirataine maybe mixed with 3.9 g of KOH stock solution, 3.9 g of the ATMP stock and 3.9 g of the EDTA stock, and the weight of the mixture may be brought up to 100 g with water. Other ways for preparing such a solution may be used as long as the final concentration of Mirataine is at 0.005% (w/w dry basis). Even when a use dilution is prepared from a stable concentrate, the concentration of individual component may be varied by adjusting the amount of the components to be added.

In another aspect, one chemical may be substituted for another with both chemicals acting as the same ingredient. For instance, NaOH may be used instead of KOH to determine whether the two different alkaline agents have different effects in scale removal.

Generally, the use solutions of the present disclosure have a pH value between 11 and 14, preferably between 12 and 13.5, more preferably between 12.5 and 13.5, and even more preferably between 12.7 and 13.2.

The present compositions may be used to treat stainless steel and other surfaces that are substantially inert to alkaline conditions. The compositions may, for example, be used where high heat has fused protein, fat, carbohydrate, mineral scale (e.g., calcium phosphate, calcium sulfate, calcium carbonate) and/or organometallic scale (e.g., calcium citrate, calcium lactate, calcium oxalate) onto the surface of processing equipment. Processes utilizing high heat in the presence of such substances include, for example, the use of evaporators, dryers, high temperature/short time pasteurizers (HTST's), batch pasteurizers, ultra-high temperature units (UHT units) and cheese vats for processing dairy products, such as milk, whey, cheese, ice cream, sour cream, yoghurt, buttermilk, starter culture, lactose, milk protein concentrate, whey protein concentrate, whey permeate, etc., and fruit and vegetable juices, tomato paste, coffee creamer, cheese and other powders, sugars and syrups. Table 1 discloses several exemplary food industry systems that may benefit from the present compositions and methods. Some equipment may be used to produce multiple products.

TABLE 2
Exemplary food industry systems that may benefit from the present
compositions and methods.

| Surface | | | |
|---|---|---|---|
| (Equipment) | Product | Process | Industry |
| Evaporator | Condensed whole | Concentrating for | Dairy |
| | milk | preparation for | |
| | | drying or reduction | |
| | | in shipping costs | |
| | Condensed skim | | |
| | milk | | |
| | Condensed milk | | |
| | protein concentrate | | |
| | Condensed whey | | |
| | Evaporated milk | | |
| | Sweetened | | |
| | condensed milk | | |
| | Whey protein | | |
| | concentrate | | |
| | Whey permeate | | |
| | Delactosed whey | | |
| | Demineralized | | |
| | whey | | |
| Evaporator | Tomato paste | Concentrating for | Vegetable |
| | | customer use | |
| Evaporator | Carrot juice | Concentrating for | Juice |
| | | preparation, drying | |
| | | or reduction in | |
| | | shipping costs | |
| Evaporator | Syrup | Concentrating for | Sweetener |
| | | preservative effect | |
| | | and customer use | |
| | Sugar | | |
| Dryer | Whey | Making a powder | Dairy |
| | | for ingredients, | |
| | | product | |
| | | functionality, or | |
| | | reducing shipping | |
| | | costs | |
| | Whey protein | | |
| | concentrate | | |
| | Whey permeate | | |
| | Skim milk powder | | |
| | Whole milk powder | | |
| | Milk protein | | |
| | concentrate | | |
| | Lactose | | |
| | Coffee creamer | | |
| | Cheese powder | | |
| | Delactosed whey | | |
| | Demineralized | | |
| | whey | | |
| Dryer | Baby formula | Customer use | Baby formula |
| HTST and surge tank | Milk | Pasteurization | Dairy |
| | Whey | | |
| | Delactosed whey | | |
| | Demineralized | | |
| | whey | | |
| | Whey ultrafiltration | | |
| | concentrate | | |
| | Whey permeate | | |
| | Milk protein | | |
| | concentrate | | |
| | permeate | | |
| HTST and surge tank | Orange juice | Pasteurization | Juice |
| | Fruit juices | | |
| | Carrot juice | | |
| | Vegetable juices | | |
| Batch pasteurizer, | Milk | Pasteurization, | Dairy |
| holding tank, | | inactivation of | |
| starter media tank, | | enzymes, affecting | |
| mix tank, etc. | | proteins for further | |
| | | processing, | |
| | | activating | |
| | | stabilizers, etc. | |
| | Sour cream | | |
| | Buttermilk | | |
| | Ice cream mix | | |
| | Yoghurt mix | | |
| | Starter media | | |
| | heating and starter | | |
| | culture tank | | |
| | Whey | | |
| UHT unit | Milk | Non-refrigerated | Dairy |
| | | convenience | |
| | Aseptically | | |
| | packaged UHT | | |
| | liquids | | |
| UHT unit | Juice | Non-refrigerated | Juice |
| | | convenience | |
| | Aseptically | | |
| | packaged UHT | | |
| | liquids | | |
| Cheese vats | Cheese | Curd processing | Dairy |
| Cheese curd | Cheese | Curd processing | Dairy |
| finishing and | | | |
| drainage tables | | | |
| Cheese curd | Cheese | Curd processing | Dairy |
| matting conveyors | | | |
| Cheese block | Cheese | Curd processing | Dairy |
| forming towers | | | |
| Grinders and | Meat tissue | Preparing ground | Red meat and |
| Blenders | | product for | poultry |
| | | consumer use | |
| CIP tanks (clean- | All industries | Holding and | All industries |
| in-place) | | circulating cleaning | |
| | | chemicals | |
| COP tanks (clean- | All industries | Utensil washing | All industries |
| out-of-place) | | tank | |
| Dolly washers, | All industries | General utensil | All industries |
| knife washer, tray | | washing | |
| washers, extension | | | |
| washers | | | |
| Conveyor washers | All industries | Conveys items | All industries |
| | | though washer | |

The present compositions might also be used in the canning, baking, pet food and ethanol industries, as well as in lower heat applications involving hard water that can contribute to mineral deposits.

A broader object of the disclosed instrumentalities is to provide a composition that may be used, for example, according to any purpose for scale inhibition and/or removal. In a particular embodiment, the composition is intended to be used to clean equipment involved in high heat processing of dairy products, where calcium ions are expected to be present in relatively high concentrations. In other embodiments, the composition is intended to be used as a water softener, a hard surface cleaner and the like.

The aforementioned compositions may be supplemented with buffering agents, pH adjusting agents, wetting agents, defoaming agents, perfumes, dyes, coupling agents and mixtures thereof. These may be present in any suitable amount.

The term “additive” shall mean any component that is not an alkaline agent, a scale inhibitor or a solvent.

### pH Adjusting Agents

It will be appreciated that at least one alkaline agent is present in the present compositions, and that the alkaline agent will affect the pH of the composition. The pH of the composition may, however, be adjusted by the addition of acidic, basic or buffering agents. Suitable acids for use as pH adjusting agents may include, for example, sulfuric acid, sulfurous acid, sulfamic acid, hydrochloric acid, phosphoric acid, phosphorous acid, C₁-C₄ fatty acids, citric acid, glycolic acid, lactic acid, acetic acid, benzoic acid, malic acid, oxalic acid, tartaric acid, succinic acid, glutaric acid, valeric acid, glycolic acid and the like. The pH may be raised, or made more alkaline, by addition of an alkaline agent such as sodium or potassium carbonate, sodium or potassium bicarbonate, sodium or potassium silicate, sodium or potassium metasilicate, sodium or potassium phosphate, sodium tripolyphosphate, potassium pyrophosphate, monosodium acid diphosphonate or combinations thereof. Traditional acid buffering agents such as citric acid, lactic acid and phosphoric acid may also be used to maintain a desired pH.

### Wetting Agents

Wetting agents may be included in the disclosed formulations. Typical wetting agents are used to wet the surface of application, thereby reducing surface tension so that the product can easily contact the surface. The wetting agents of the formulation increase overall detergency of the formula, solubilize or emulsify organic ingredients that otherwise might not dissolve or emulsify, and facilitate penetration of active ingredients deep into depressions of the surface.

Suitably effective wetting agents may include anionic, nonionic, zwitterionic and amphoteric surfactants. Wetting agents and surfactants suitable for use in the disclosed formulations are typically non-foaming. Suitable anionic surfactants can be chosen from alkyl sulfonic acid, an alkyl sulfonate salt, a linear alkyl benzene sulfonic acid, a linear alkyl benzene sulfonate, an alkyl α-sulfomethyl ester, an α-olefin sulfonate, an alcohol ether sulfate, an alkyl sulfate, an alkylsulfo succinate, a dialkylsulfo succinate, or alkali metal, alkaline earth metal, amine and ammonium salts thereof. Specific examples are linear C₁₀-C₁₆ alkylbenzene sulfonic acid, linear C₁₀-C₁₆ alkylbenzene sulfonate or alkali metal, alkaline earth metal, amine and ammonium salts thereof, e.g., sodium dodecylbenzene sulfonate, sodium C₁₄-C₁₆ α-olefin sulfonate, sodium methyl α-sulfomethyl ester and disodium methyl α-sulfo fatty acid salts. Suitable nonionic surfactants can be chosen from alkyl polyglucoside, alkyl ethoxylated alcohol, alkyl propoxylated alcohol, ethoxylated-propoxylated alcohol, sorbitan, sorbitan ester and alkanol amide. Specific examples include C₈-C₁₆ alkyl polyglucoside with a degree of polymerization ranging from 1 to 3 e.g., C₈-C₁₀ alkyl polyglucoside with a degree of polymerization of 1.5 (Glucopon® 200), C₈-C₁₆ alkyl polyglucoside with a degree of polymerization of 1.45 (Glucopon® 425), C₁₂-C₁₆ alkyl polyglucoside with a degree of polymerization of 1.6 (Glucopon® 625), and polyethoxylated polyoxypropylene block copolymers (poloxamers) including by way of example the Pluronic® poloxamers commercialized by BASF Chemical Co. Amphoteric surfactants can be chosen from alkyl betaines, alkyl amphoacetates and alkylether hydroxypropyl sultaines. Suitable betaines include, for example, cocoamidopropyl betaine. Suitable amphoacetates include, for example, sodium cocoamphoacetate, sodium lauroamphoacetate and sodium cocoamphodiacetate. Suitable alkylether hydroxypropyl sultaines include, for example, Mirataine® ASC, described in U.S. Pat. No. 4,891,159, which is incorporated herein by reference. The amount of wetting agent in the stable concentrate is generally between 0.0001% and 5% (w/w, dry basis), preferably between 0.0005% and 2%, even more preferably from 0.01% to 1% (w/w, dry basis), and most preferably around 0.25% (w/w, dry basis).

### Defoaming Agents

A defoaming agent may be used in the disclosed compositions. Typical defoaming agents include a silicone compound including silica dispersed in polydimethylsiloxane; fatty amides; hydrocarbon waxes; fatty acids; fatty esters; fatty alcohols; fatty acid soaps; ethoxylates; mineral oils; polyethylene glycol esters; polyoxyethylene-polyoxypropylene block coploymers; alkyl phosphate esters such as monostearyl phosphate and the like. The amount of defoaming agent in the stable concentrate is generally between 0.0001%-5% (w/w, dry basis), preferably between 0.0005%-3% and more preferably between 0.001-1%.

### Coupling Agents

In some embodiments, a composition may contain a coupling agent that facilitates dissolution of one or more components, e.g., surfactants or fatty acids that would otherwise be insoluble or only sparingly soluble in the solvent. Coupling agents generally contain short chained (C₂-C₆) moieties linked to bulky hydrophilic groups, such as hydroxyl and/or sulfonate groups. Exemplary coupling agents include aryl sulfonates such as sodium naphthalene sulfonate, sodium octane sulfonate, sodium xylene sulfonate, and ammonium octane sulfonate, as well as some phosphate esters.

The disclosed compositions may be used to remove scale from and/or inhibit formation of scale on an article. The article, which may form part of a system, may be contacted with a composition. The act of contacting may include agitating, spraying, wiping, mixing, circulating and the like. Once the article is clean, it may be rinsed, for example with water, to remove extraneous composition. The system may then be operated according to its intended function for an extended period of time before a subsequent cleaning is necessary.

The present methods may utilize a reduced amount of caustic and/or acidic wash compared to the amount of wash normally employed in a conventional cleaning method where protein, fat, carbohydrate and/or mineral scale are encountered. By reducing the amount of wash used during cleaning, less chemical waste may be produced resulting in lower disposal costs, equipment efficiency may be improved resulting in reduced energy usage, less water may be used, system run times may be extended between cleanings and equipment may experience less corrosion.

### Example 1

### Preparation of Ause Dilution that Removes Scale and/or Inhibits Scale Formation

In one embodiment, a use dilution was prepared by dissolving 3.9 g of a stable concentrate also known as E1 in about 50 g of water. The total volume of the resulting solution was then brought up with water so that the weight of the final use solution is 100 grams. The final solution had a pH of greater than 13. The concentrations by weight (dry basis) of individual components in the use dilution are as shown in the last column of Table 1.

### Example 2

### Treatment of an Evaporator Using a Conventional Method and a Method According to the Present Disclosure

Table 3 shows a comparison of a conventional descaling method (conventional method, “C”) using a solution of 50% sodium hydroxide and a descaling method using the composition of Example 1 (present method, “P”).

According to the conventional method, a low heat condensed skim milk evaporator was washed with both 50% NaOH and acid to complete a full cleaning cycle. The evaporator was then run for 24 hours until it became sufficiently coated with scale that heat transfer was reduced below an acceptable level, as indicated by a temperature of about 175-180° F. A second caustic wash was performed on the evaporator using 50% NaOH. When the wash was complete, the evaporator ran for about 16 hours before requiring a second complete wash. At times of the year when milk volume is high, a caustic flush may be used to extend a run about 12 additional hours before performing a second complete wash. A caustic flush was performed during the experiment described in Table 3. The total run time of the evaporator operated according to the conventional method was 52 hours.

Using a treatment method described herein, a low heat condensed skim milk evaporator was washed with both the composition of Example 1 (“E1”) and acid to complete a full cleaning cycle. The evaporator was then run for 31 hours until it became sufficiently coated with scale that heat transfer was reduced below an acceptable level, as indicated by a temperature of about 170° F. A second E1 wash was performed on the evaporator. When the wash was complete, the evaporator ran for about 30 hours before requiring another wash. Following a third E1 flush the evaporator ran for 24 hours. The total run time of the evaporator operated according to the present method was 85 hours.

In the conventional process, the full alkaline and acid cleaning steps were necessary after a 52 hour product run. With the present process, the system was run for a total of 85 hours before cleaning with acid became necessary. The estimated value of the extended run time was about $160,000, which represents total net gains from sales of extra product minus cleaning costs. Additional savings were realized by the use of lower volumes of descaling product and less energy consumption. The amount of E1 required for washing and flushing was approximately half of the amount of NaOH required by the conventional method, and utility savings were realized due to reduced steam consumption.

TABLE 3
Comparison of Conventional Method and Present Method

| | | | | | | | | | Temp of | |
|---|---|---|---|---|---|---|---|---|---|---|
| | | | | | | | | | Evaporator at | |
| | | | Temperature | | Component | | Amount of | | end of run. | |
| | Duration of Step | | of Step (° F.) | | Used in Step | | Component | | Start ~160° F. | |
| Step | C | P | C | P | C | P | C | P | C | P |
| Rinse | 15-30 min | 15-30 min | 110 | 110 | | | | | | |
| evaporator | | | | | | | | | | |
| until rinse | | | | | | | | | | |
| water is | | | | | | | | | | |
| clear | | | | | | | | | | |
| Pre-caustic | 30 min | 30 min | 165 | 165 | 50% | E1 | 20 gal | 10 gal | | |
| treatment | | | | | NaOH | | | | | |
| (circulate) | | | | | | | | | | |
| Rinse | 15-30 min | 15-30 min | | | | | | | | |
| evaporator | | | | | | | | | | |
| until rinse | | | | | | | | | | |
| water is | | | | | | | | | | |
| clear | | | | | | | | | | |
| Caustic | 60-90 min | 60-90 min | | | 50% | E1 | 200 gal | 100 gal | | |
| wash | | | | | NaOH | | | | | |
| (circulate) | | | | | | | | | | |
| Rinse | 15-30 min | 15-30 min | | | | | | | | |
| evaporator | | | | | | | | | | |
| until rinse | | | | | | | | | | |
| water is | | | | | | | | | | |
| clear | | | | | | | | | | |
| Acid wash | 30 min | 30 min | | | HT | HT | 90 gal | 90 gal | | |
| (circulate) | | | | | Acid | Acid | | | | |
| | | | | | 445* | 445* | | | | |
| Rinse | 15-30 min | 15-30 min | | | | | | | | |
| evaporator | | | | | | | | | | |
| until rinse | | | | | | | | | | |
| water pH is | | | | | | | | | | |
| neutral | | | | | | | | | | |
| Product run | 24 h | 31 h | | | | | | | 175-180° F. | ~170° F. |
| Rinse | 15-30 min | 15-30 min | | | | | | | | |
| evaporator | | | | | | | | | | |
| until rinse | | | | | | | | | | |
| water is | | | | | | | | | | |
| clear | | | | | | | | | | |
| Caustic | 30-45 min | 30-45 min | | | 50% | E1 | 130 gal | 50 gal | | |
| wash | | | | | NaOH | | | | | |
| (circulate) | | | | | | | | | | |
| Rinse | 15-30 min | 15-30 min | | | | | | | | |
| evaporator | | | | | | | | | | |
| until rinse | | | | | | | | | | |
| water pH is | | | | | | | | | | |
| neutral | | | | | | | | | | |
| Product run | 16 h | 30 h | | | | | | | 175-180° F. | ~170° F. |
| Rinse | 15-30 min | 15-30 min | | | | | | | | |
| evaporator | | | | | | | | | | |
| until rinse | | | | | | | | | | |
| water is | | | | | | | | | | |
| clear | | | | | | | | | | |
| Caustic flush | 15-30 min | 15-30 min | | | 50% | E1 | Recovered | Recovered | | |
| | | | | | NaOH | | NaOH | E1 | | |
| Rinse | 15-30 min | 15-30 min | | | | | | | | |
| evaporator | | | | | | | | | | |
| until rinse | | | | | | | | | | |
| water is | | | | | | | | | | |
| clear | | | | | | | | | | |
| Run re-used | 30-45 min | 30-45 min | | | | | | | | |
| caustic | | | | | | | | | | |
| through | | | | | | | | | | |
| evaporator | | | | | | | | | | |
| Rinse | 15-30 min | 15-30 min | | | | | | | | |
| evaporator | | | | | | | | | | |
| until rinse | | | | | | | | | | |
| water pH is | | | | | | | | | | |
| neutral | | | | | | | | | | |
| Product run | 12 h | 24 h | | | | | | | 175-180° F. | ~170° F. |
| Total | 52 h | 85 h | | | | | | | | |
| product run | | | | | | | | | | |
| Estimated | | $160,000 | | | | | | | | |
| value of | | | | | | | | | | |
| extended | | | | | | | | | | |
| product run | | | | | | | | | | |

*HT Acid 445 DeLaval Cleaning Solution is approximately 35% nitric acid and 5% phosphoric acid.

### Example 3

### Treatment of a Skim Milk HTST Using a Conventional Method and a Method According to the Present Disclosure

Table 4 shows a comparison of a conventional descaling method (conventional method, “C”) using a solution of 50% sodium hydroxide and a descaling method using the composition of Example 1 (present method, “P”).

According to the conventional method, a skim milk HTST was washed with both 50% NaOH and acid to complete a full cleaning cycle. The skim milk HTST was then run for 24 hours. A second caustic wash was performed on the skim milk HTST using 50% NaOH. When the wash was complete, the skim milk HTST ran for about 16 hours before requiring a second complete wash. At times of the year when milk volume is high, a caustic flush may be used to extend a run about 12 additional hours before performing the second complete wash. A caustic flush was performed during the experiment described in Table 4. The total run time of the skim milk HTST operated according to the conventional method was 52 hours.

Using a treatment method described herein, a skim milk HTST was washed with both the composition of Example 1 (“E1”) and acid to complete a full cleaning cycle. The skim milk HTST was then run for 31 hours until it became sufficiently coated with scale that heat transfer was reduced below an acceptable level, as indicated by a temperature of about 165° F. A second E1 wash was performed on the skim milk HTST When the wash was complete, the skim milk HTST ran for about 30 hours before requiring another wash. Following a third E1 flush the skim milk HTST ran for 24 hours. The total run time of the skim milk HTST operated according to the present method was 85 hours.

Savings were realized based on increased product yield from extended run time and less energy consumption. Utility savings were realized due to reduced steam consumption.

TABLE 4
Comparison of Conventional Method and Present Method

| | | | Temperature | | Component | | Amount of | |
|---|---|---|---|---|---|---|---|---|
| | Duration of Step | | of Step (° F.) | | Used in Step | | Component | |
| Step | C | P | C | P | C | P | C | P |
| Rinse skim milk | 15 min | 15 min | 110 | 110 | | | | |
| HTST until rinse | | | | | | | | |
| water is clear | | | | | | | | |
| Pre-caustic | 15 min | 15 min | 110 | 110 | 50% | E1 | 25 gal | 15 gal |
| treatment | | | | | NaOH | | | |
| (circulate) | | | | | | | | |
| Rinse skim milk | 10 min | 10 min | 110 | 110 | | | | |
| HTST until rinse | | | | | | | | |
| water is clear | | | | | | | | |
| Caustic wash | 30-45 min | 30-45 min | 180 | 180 | 50% | E1 | 120 gal | 60 gal |
| (circulate) | | | | | NaOH | | | |
| Rinse skim milk | 15 min | 15 min | 110 | 110 | | | | |
| HTST until rinse | | | | | | | | |
| water is clear | | | | | | | | |
| Acid wash | 20 min | 20 min | 145 | 145 | HT | HT | 80 gal | 80 gal |
| (circulate) | | | | | Acid | Acid | | |
| | | | | | 445* | 445* | | |
| Rinse skim milk | 10 min | 10 min | 110 | 110 | | | | |
| HTST until rinse | | | | | | | | |
| water pH is | | | | | | | | |
| neutral | | | | | | | | |
| Product run | 24 h | 31 h | 165 | 165 | | | | |
| Rinse skim milk | 15 min | 15 min | 110 | 110 | | | | |
| HTST until rinse | | | | | | | | |
| water is clear | | | | | | | | |
| Caustic wash | 30 min | 30 min | 180 | 180 | 50% | E1 | 100 gal | 60 gal |
| (circulate) | | | | | NaOH | | | |
| Rinse skim milk | 15 min | 15 min | 110 | 110 | | | | |
| HTST until rinse | | | | | | | | |
| water pH is | | | | | | | | |
| neutral | | | | | | | | |
| Product run | 16 h | 30 h | 165 | 165 | | | | |
| Rinse skim milk | 15 min | 15 min | 110 | 110 | | | | |
| HTST until rinse | | | | | | | | |
| water is clear | | | | | | | | |
| Caustic flush | 15 min | 15 min | 180 | 180 | 50% | E1 | 80 gal | 50 gal |
| | | | | | NaOH | | | |
| Rinse skim milk | 15 min | 15 min | 110 | 110 | | | | |
| HTST until rinse | | | | | | | | |
| water is clear | | | | | | | | |
| Run re-used | 30 min | 30 min | 110 | 110 | | | | |
| caustic through | | | | | | | | |
| skim milk HTST | | | | | | | | |
| Rinse skim milk | 15 min | 15 min | 110 | 110 | | | | |
| HTST until rinse | | | | | | | | |
| water pH is | | | | | | | | |
| neutral | | | | | | | | |
| Product run | 12 h | 24 h | 165 | 165 | | | | |
| Total product run | 52 h | 85 h | | | | | | |

*HT Acid 445 DeLaval Cleaning Solution is approximately 35% nitric acid and 5% phosphoric acid.

### Example 4

### Treatment of a Cream HTST Using a Conventional Method and a Method According to the Present Disclosure

Table 5 shows a comparison of a conventional descaling method (conventional method, “C”) using a solution of 50% sodium hydroxide and a descaling method using the composition of Example 1 (present method, “P”).

According to the conventional method, a cream HTST was washed with both 50% NaOH and acid to complete a full cleaning cycle. The cream HTST was then run for 24 hours until it became sufficiently coated with scale that heat transfer was reduced below an acceptable level, as indicated by a temperature of about 165° F. A second caustic wash was performed on the cream HTST using 50% NaOH. When the wash was complete, the cream HTST ran for about 16 hours before requiring a second complete wash. At times of the year when milk volume is high, a caustic flush may be used to extend a run about 12 additional hours before performing the second complete wash. A caustic flush was performed during the experiment described in Table 5. The total run time of the cream HTST operated according to the conventional method was 52 hours.

Using a treatment method described herein, a cream HTST was washed with both the composition of Example 1 (“E1”) and acid to complete a full cleaning cycle. The cream HTST was then run for 31 hours. A second E1 wash was performed on the cream HTST. When the wash was complete, the cream HTST ran for about 30 hours before requiring another wash. Following a third E1 flush the cream HTST ran for 24 hours. The total run time of the cream HTST operated according to the present method was 85 hours.

Savings were realized based on increased product yield from extended run time and less energy consumption. Utility savings were realized due to reduced steam consumption.

TABLE 5
Comparison of Conventional Method and Present Method

| | | | Temperature | | Component | | Amount of | |
|---|---|---|---|---|---|---|---|---|
| | Duration of Step | | of Step (° F.) | | Used in Step | | Component | |
| Step | C | P | C | P | C | P | C | P |
| Rinse cream | 15 min | 15 min | 110 | 110 | | | | |
| HTST until | | | | | | | | |
| rinse water | | | | | | | | |
| is clear | | | | | | | | |
| Pre-caustic | 15 min | 15 min | 110 | 110 | 50% | E1 | 5 gal | 3 gal |
| treatment | | | | | NaOH | | | |
| (circulate) | | | | | | | | |
| Rinse cream | 10 min | 10 min | 110 | 110 | | | | |
| HTST until | | | | | | | | |
| rinse water | | | | | | | | |
| is clear | | | | | | | | |
| Caustic | 30-45 min | 30-45 min | 180 | 180 | 50% | E1 | 25 gal | 12 gal |
| wash | | | | | NaOH | | | |
| (circulate) | | | | | | | | |
| Rinse cream | 15 min | 15 min | 110 | 110 | | | | |
| HTST until | | | | | | | | |
| rinse water | | | | | | | | |
| is clear | | | | | | | | |
| Acid wash | 20 min | 20 min | 145 | 145 | HT | HT | 20 gal | 20 gal |
| (circulate) | | | | | Acid | Acid | | |
| | | | | | 445* | 445* | | |
| Rinse cream | 10 min | 10 min | 110 | 110 | | | | |
| HTST until | | | | | | | | |
| rinse water | | | | | | | | |
| pH is | | | | | | | | |
| neutral | | | | | | | | |
| Product run | 24 h | 31 h | 165 | 165 | | | | |
| Rinse cream | 15 min | 15 min | 110 | 110 | | | | |
| HTST until | | | | | | | | |
| rinse water | | | | | | | | |
| is clear | | | | | | | | |
| Caustic | 30 min | 30 min | 180 | 180 | 50% | E1 | 25 gal | 12 gal |
| wash | | | | | NaOH | | | |
| (circulate) | | | | | | | | |
| Rinse cream | 15 min | 15 min | 110 | 110 | | | | |
| HTST until | | | | | | | | |
| rinse water | | | | | | | | |
| pH is | | | | | | | | |
| neutral | | | | | | | | |
| Product run | 16 h | 30 h | 165 | 165 | | | | |
| Rinse cream | 15 min | 15 min | 110 | 110 | | | | |
| HTST until | | | | | | | | |
| rinse water | | | | | | | | |
| is clear | | | | | | | | |
| Caustic | 15 min | 15 min | 180 | 180 | 50% | E1 | 25 gal | 12 gal |
| flush | | | | | NaOH | | | |
| Rinse cream | 15 min | 15 min | 110 | 110 | | | | |
| HTST until | | | | | | | | |
| rinse water | | | | | | | | |
| is clear | | | | | | | | |
| Run re-used | 30 min | 30 min | 110 | 110 | | | | |
| caustic | | | | | | | | |
| through | | | | | | | | |
| cream | | | | | | | | |
| HTST | | | | | | | | |
| Rinse cream | 15 min | 15 min | 110 | 110 | | | | |
| HTST until | | | | | | | | |
| rinse water | | | | | | | | |
| pH is | | | | | | | | |
| neutral | | | | | | | | |
| Product run | 12 h | 24 h | 165 | 165 | | | | |
| Total | 52 h | 85 h | | | | | | |
| product run | | | | | | | | |

*HT Acid 445 DeLaval Cleaning Solution is approximately 35% nitric acid and 5% phosphoric acid.

### Example 5

### Treatment of a CER Evaporator Cream HTST Using a Conventional Method and a Method According to the Present Disclosure

Table 6 shows a comparison of a conventional descaling method (conventional method, “C”) using a solution of 50% sodium hydroxide and a descaling method using the composition of Example 1 (present method, “P”).

According to the conventional method, a CER evaporator cream HTST (C. E. Rogers Company, Mora, Minn.) was washed with both 50% NaOH and acid to complete a full cleaning cycle. The evaporator was then run for 24 hours until it became sufficiently coated with scale that heat transfer was reduced below an acceptable level, as indicated by a temperature of about 165° F. A second caustic wash was performed on the evaporator using 50% NaOH. When the wash was complete, the evaporator ran for about 16 hours before requiring a second complete wash. At times of the year when milk volume is high, a caustic flush may be used to extend a run about 12 additional hours before performing the second complete wash. A caustic flush was performed during the experiment described in Table 6. The total run time of the evaporator operated according to the conventional method was 52 hours.

Using a treatment method described herein, a CER evaporator cream HTST (C. E. Rogers Company, Mora, Minn.) was washed with both the composition of Example 1 (“E1”) and acid to complete a full cleaning cycle. The evaporator was then run for 31 hours. A second E1 wash was performed on the evaporator. When the wash was complete, the evaporator ran for about 30 hours before requiring another wash. Following a third E1 flush the evaporator ran for 24 hours. The total run time of the evaporator operated according to the present method was 85 hours.

Savings were realized based on increased product yield from extended run time and less energy consumption. Utility savings were realized due to reduced steam consumption.

TABLE 6
Comparison of Conventional Method and Present Method

| | | | Temperature | | Component | | Amount of | |
|---|---|---|---|---|---|---|---|---|
| | Duration of Step | | of Step (° F.) | | Used in Step | | Component | |
| Step | C | P | C | P | C | P | C | P |
| Rinse CER | 15 min | 15 min | 110 | 110 | | | | |
| evaporator | | | | | | | | |
| cream HTST | | | | | | | | |
| until rinse | | | | | | | | |
| water is clear | | | | | | | | |
| Pre-caustic | 15 min | 15 min | 110 | 110 | 50% | E1 | 5 gal | 3 gal |
| treatment | | | | | NaOH | | | |
| (circulate) | | | | | | | | |
| Rinse CER | 10 min | 10 min | 110 | 110 | | | | |
| evaporator | | | | | | | | |
| cream HTST | | | | | | | | |
| until rinse | | | | | | | | |
| water is clear | | | | | | | | |
| Caustic wash | 30-45 min | 30-45 min | 180 | 180 | 50% | E1 | 25 gal | 12 gal |
| (circulate) | | | | | NaOH | | | |
| Rinse CER | 15 min | 15 min | 110 | 110 | | | | |
| evaporator | | | | | | | | |
| cream HTST | | | | | | | | |
| until rinse | | | | | | | | |
| water is clear | | | | | | | | |
| Acid wash | 20 min | 20 min | 145 | 145 | HT | HT | 20 gal | 20 gal |
| (circulate) | | | | | Acid | Acid | | |
| | | | | | 445* | 445* | | |
| Rinse CER | 10 min | 10 min | 110 | 110 | | | | |
| evaporator | | | | | | | | |
| cream HTST | | | | | | | | |
| until rinse | | | | | | | | |
| water pH is | | | | | | | | |
| neutral | | | | | | | | |
| Product run | 24 h | 31 h | 165 | 165 | | | | |
| Rinse CER | 15 min | 15 min | 110 | 110 | | | | |
| evaporator | | | | | | | | |
| cream HTST | | | | | | | | |
| until rinse | | | | | | | | |
| water is clear | | | | | | | | |
| Caustic wash | 30 min | 30 min | 180 | 180 | 50% | E1 | 25 gal | 12 gal |
| (circulate) | | | | | NaOH | | | |
| Rinse CER | 15 min | 15 min | 110 | 110 | | | | |
| evaporator | | | | | | | | |
| cream HTST | | | | | | | | |
| until rinse | | | | | | | | |
| water pH is | | | | | | | | |
| neutral | | | | | | | | |
| Product run | 16 h | 30 h | 165 | 165 | | | | |
| Rinse CER | 15 min | 15 min | 110 | 110 | | | | |
| evaporator | | | | | | | | |
| cream HTST | | | | | | | | |
| until rinse | | | | | | | | |
| water is clear | | | | | | | | |
| Caustic flush | 15 min | 15 min | 180 | 180 | 50% | E1 | 25 gal | 12 gal |
| | | | | | NaOH | | | |
| Rinse CER | 15 min | 15 min | 110 | 110 | | | | |
| evaporator | | | | | | | | |
| cream HTST | | | | | | | | |
| until rinse | | | | | | | | |
| water is clear | | | | | | | | |
| Run re-used | 30 min | 30 min | 110 | 110 | | | | |
| caustic through | | | | | | | | |
| CER | | | | | | | | |
| evaporator | | | | | | | | |
| cream HTST | | | | | | | | |
| Rinse CER | 15 min | 15 min | 110 | 110 | | | | |
| evaporator | | | | | | | | |
| cream HTST | | | | | | | | |
| until rinse | | | | | | | | |
| water pH is | | | | | | | | |
| neutral | | | | | | | | |
| Product run | 12 h | 24 h | 165 | 165 | | | | |
| Total product | 52 h | 85 h | | | | | | |
| run | | | | | | | | |

*HT Acid 445 DeLaval Cleaning Solution is approximately 35% nitric acid and 5% phosphoric acid.

### Example 6

### Treatment of Cheese Manufacturing Equipment Using a Conventional Method and a Method According to the Present Disclosure

Table 7 shows a comparison of a conventional descaling method (conventional method, “C”) using a solution of 50% sodium hydroxide and a descaling method using the composition of Example 1 (present method, “P”).

According to the conventional method, a cheese vat, matting conveyor, mill and block former are washed with both 50% NaOH and acid to complete a full cleaning cycle. The equipment is then sanitized, drained and used in its conventional manner (NC=no change).

Using a treatment method described herein, a cheese vat, matting conveyor, mill and block former are washed with the composition of Example 1 (“E1”), but no acid. The equipment is then sanitized, drained and used in its conventional manner (NC=no change). Approximately 147 minutes may be saved by eliminating acid wash and subsequent rinsing steps. Additional savings may be realized by reduced corrosion of equipment.

TABLE 7
Comparison of Conventional Method and Present Method

| | Duration | | Temperature | | Component | | Amount of | |
|---|---|---|---|---|---|---|---|---|
| | of Step | | of Step (° F.) | | Used in Step | | Component | |
| Step | C | P | C | P | C | P | C | P |
| Manufacturing | | | | | | | | |
| cheese in a vat | | | | | | | | |
| Rinse cheese vat | 5 min | 5 min | 90 | 90 | | | | |
| until rinse water | | | | | | | | |
| is clear | | | | | | | | |
| Caustic wash | 12 min | 12 min | 155 | 155 | 50% | E1 | 4000 ppm | 3000 ppm |
| (circulate) | | | | | NaOH | | active | active |
| | | | | | | | alkalinity | alkalinity |
| Rinse cheese vat | 5 min | 5 min | 90 | 90 | | | | |
| until rinse water | | | | | | | | |
| pH is neutral | | | | | | | | |
| Acid wash | 6 min | | 155 | | 5:1 | | 5000 ppm | |
| (circulate) | | | | | HNO₃:H₃PO₄ | | acidity | |
| Rinse cheese vat | 5 min | | 90 | | | | | |
| until rinse water | | | | | | | | |
| pH is neutral | | | | | | | | |
| Sanitize | 2 min | 2 min | 90 | 90 | chlorine | chlorine | 100 ppm | 100 ppm |
| Drain | 5 min | 5 min | 90 | 90 | | | | |
| Make cheese as | NC | NC | | | | | | |
| usual | | | | | | | | |
| Time saved | | 11 min | | | | | | |
| Cleaning | | | | | | Acid wash | | Less |
| compound | | | | | | eliminated, | | alkalinity |
| eliminated or | | | | | | acid rinse | | used, less |
| reduced, | | | | | | eliminated, | | corrosion |
| corrosion reduced | | | | | | less | | of surface |
| | | | | | | corrosion of | | |
| | | | | | | surface | | |
| Matting | | | | | | | | |
| Conveyor | | | | | | | | |
| (Cheddaring | | | | | | | | |
| Step) | | | | | | | | |
| Rinse matting | 30 min | 30 min | 90 | 90 | | | | |
| conveyor until | | | | | | | | |
| curd is removed | | | | | | | | |
| and rinse water is | | | | | | | | |
| clear | | | | | | | | |
| Caustic wash | 60 min | 60 min | 155 | 155 | 50% | E1 | 4000 ppm | 3000 ppm |
| (circulate) | | | | | NaOH | | active | active |
| | | | | | | | alkalinity | alkalinity |
| Rinse matting | 15 min | 15 min | 90 | 90 | | | | |
| conveyor until | | | | | | | | |
| rinse water pH is | | | | | | | | |
| neutral | | | | | | | | |
| Acid wash | 60 min | | 155 | | 5:1 | | 5000 ppm | |
| | | | | | HNO₃:H₃PO₄ | | acidity | |
| Rinse matting | 15 min | | 90 | | | | | |
| conveyor until | | | | | | | | |
| rinse water pH is | | | | | | | | |
| neutral | | | | | | | | |
| Sanitize | 2 min | 2 min | 90 | 90 | chlorine | chlorine | 100 ppm | 100 ppm |
| Drain | 5 min | 5 min | 90 | 90 | | | | |
| Matting as Usual | NC | NC | | | | | | |
| Time saved | | 75 min | | | | | | |
| Cleaning | | | | | | Acid wash | | Less |
| compound | | | | | | eliminated, | | alkalinity |
| eliminated or | | | | | | acid rinse | | used, less |
| reduced, | | | | | | eliminated, | | corrosion |
| corrosion reduced | | | | | | less | | of surface |
| | | | | | | corrosion of | | |
| | | | | | | surface | | |
| Milling (Cutting | | | | | | | | |
| Mat) | | | | | | | | |
| Rinse mill until | 10 min | 10 min | 90 | 90 | | | | |
| curd is removed | | | | | | | | |
| and rinse water is | | | | | | | | |
| clear | | | | | | | | |
| Caustic wash | 10 min | 10 min | 155 | 155 | 50% | E1 | 4000 ppm | 3000 ppm |
| | | | | | NaOH | | active | active |
| | | | | | | | alkalinity | alkalinity |
| Rinse mill until | 5 min | 5 min | 90 | 90 | | | | |
| rince water pH is | | | | | | | | |
| neutral | | | | | | | | |
| Acid wash | 6 min | | 155 | | 5:1 | | 5000 ppm | |
| | | | | | HNO₃:H₃PO₄ | | acidity | |
| Rinse mill until | 5 min | | 90 | 90 | | | | |
| rinse water pH is | | | | | | | | |
| neutral | | | | | | | | |
| Sanitize | 2 min | 2 min | 90 | 90 | chlorine | chlorine | 100 ppm | 100 ppm |
| Drain | 5 min | 5 min | 90 | 90 | | | | |
| Matting as usual | NC | NC | | | | | | |
| Time saved | | 11 min | | | | | | |
| Cleaning | | | | | | Acid wash | | Less |
| compound | | | | | | eliminated, | | alkalinity |
| eliminated or | | | | | | acid rinse | | used, less |
| reduced, | | | | | | eliminated, | | corrosion |
| corrosion reduced | | | | | | less | | of surface |
| | | | | | | corrosion of | | |
| | | | | | | surface | | |
| Block Forming | | | | | | | | |
| Rinse block | 15 min | 15 min | 90 | 90 | | | | |
| former until curd | | | | | | | | |
| is removed and | | | | | | | | |
| rinse water is | | | | | | | | |
| clear | | | | | | | | |
| Caustic wash | 60 min | 60 min | 155 | 155 | 50% | E1 | 4000 ppm | 3000 ppm |
| | | | | | NaOH | | active | active |
| | | | | | | | alkalinity | alkalinity |
| Rinse block | 15 min | 15 min | 90 | 90 | | | | |
| former until rinse | | | | | | | | |
| water pH is | | | | | | | | |
| neutral | | | | | | | | |
| Acid wash | 40 min | | 155 | | 5:1 | | 5000 ppm | |
| | | | | | HNO₃:H₃PO₄ | | acidity | |
| Rinse block | 10 min | | 90 | | | | | |
| former until rinse | | | | | | | | |
| water pH is | | | | | | | | |
| neutral | | | | | | | | |
| Sanitize | 2 min | 2 min | 90 | 90 | chlorine | chlorine | 100 ppm | 100 ppm |
| Drain | 5 min | 5 min | 90 | 90 | | | | |
| Block forming as | NC | NC | | | | | | |
| Usual | | | | | | | | |
| Time saved | | 50 min | | | | | | |
| Cleaning | | | | | | Acid wash | | Less |
| compound | | | | | | eliminated, | | alkalinity |
| eliminated or | | | | | | acid rinse | | used, less |
| reduced, | | | | | | eliminated, | | corrosion |
| corrosion reduced | | | | | | less | | of surface |
| | | | | | | corrosion of | | |
| | | | | | | surface | | |
| Total extra | | 147 min | | | | | | |
| production time | | | | | | | | |
| per day | | | | | | | | |

### Example 7

### Treatment of a Carrot Juice Evaporator Using a Conventional Method and a Method According to the Present Disclosure

Table 8 shows a comparison of a conventional descaling method (conventional method, “C”) using a solution of 50% NaOH plus a chelator and a descaling method using the composition of Example 1 (present method, “P”).

According to the conventional method, a carrot juice evaporator was washed twice with 50% NaOH plus chelator and twice with acid to complete a full cleaning cycle. The evaporator was then run for 72 hours.

Using a treatment method described herein, a carrot juice evaporator was washed once with the composition of Example 1 (“E1”) and once with acid to complete a full cleaning cycle. The evaporator was then run for 72 hours.

Savings were realized based on reduced down time due to the elimination of one caustic cycle and one acid cycle, use of lower volumes of water due to elimination of some washing steps (e.g., a 700 gallon system may use approximately 3700 fewer gallons of water), use of lower volumes of acid due to elimination of an acid washing step, and less energy consumption due to ˜40% reduction in steam usage.

TABLE 8
Comparison of Conventional Method and Present Method

| | | | Temperature | | Component | | Amount of | |
|---|---|---|---|---|---|---|---|---|
| | Duration of Step | | of Step (° F.) | | Used in Step | | Component | |
| Step | C | P | C | P | C | P | C | P |
| Rinse | 15-30 min | 15-30 min | 120 | 120 | | | | |
| evaporator until | | | | | | | | |
| rinse water is | | | | | | | | |
| clear | | | | | | | | |
| Pre-caustic | 60 min | | 185 | | 50% NaOH | | 20 gal | |
| treatment | | | | | plus | | | |
| (circulate) | | | | | chelator | | | |
| Rinse | 15-30 min | | 120 | | | | | |
| evaporator until | | | | | | | | |
| rinse water is | | | | | | | | |
| clear | | | | | | | | |
| Caustic wash | 60 min | 90 min | 185 | 185 | 50% NaOH | E1 | 20 gal | 65 gal |
| (circulate) | | | | | plus | | | |
| | | | | | chelator | | | |
| Rinse | 15-30 min | 15-30 min | 120 | 120 | | | | |
| evaporator until | | | | | | | | |
| rinse water is | | | | | | | | |
| clear | | | | | | | | |
| Acid wash | 60 min | 60 min | 165 | 165 | HT Acid | HT | 20 gal | 25 gal |
| (circulate) | | | | | 445* | Acid | | |
| | | | | | | 445* | | |
| Rinse | 15-30 min | 15-30 min | 120 | 120 | | | | |
| evaporator until | | | | | | | | |
| rinse water pH | | | | | | | | |
| is neutral | | | | | | | | |
| Acid wash | 60 min | | 165 | | HT Acid | | 20 gal | |
| (circulate) | | | | | 445* | | | |
| Rinse | 15-30 min | | 120 | | | | | |
| evaporator until | | | | | | | | |
| rinse water pH | | | | | | | | |
| is neutral | | | | | | | | |
| Sanitize | 10 min | 10 min | 120 | 120 | PAA | PAA | 2 gal | 2 gal |
| | | | | | 5.6% | 5.6% | | |
| Product run | 72 h | 72 h | | | | | | |
| Total product | 72 h | 72 h | | | | | | |
| run | | | | | | | | |

*HT Acid 445 DeLaval Cleaning Solution is approximately 35% nitric acid and 5% phosphoric acid.
PAA: Peracetic Acid

### Example 8

### Coupon Test to Evaluate Different Cleaning Formulae

The effects of various cleaner formulae were compared for their capability to remove scales using a soiled coupon (also called the “Coupon Test”). Briefly, replicate of stainless steel coupons were soiled and subject to different cleaner composition to determine the extent to which the coupons were cleaned by the different cleaners. Identical stainless steel coupons (12 mm wide×77 mm long×3 mm thick, made of stainless steel type 304) were used. Uncapped 125-ml capacity square French bottles were placed on a tray so that the French bottles were laying on their sides. The coupons were placed inside the French bottles. 15 ml of 2% fat milk were then placed in each bottle so that the coupons were covered by the milk. The bottles with coupons and milk were then heated at 105° C. for 24 hours to allow a layer of milk scale to form over the coupons.

The coupons were removed from the bottles and then scraped to remove excess scale hanging off the sides of the coupons. At this point, all coupons were covered by a thin layer of 2% milk scale, primarily composed of fat, protein and minerals. The minerals were mostly calcium phosphate. The presence of some proteins, in this case milk proteins, appeared to be necessary for the scale to bind tightly to the surface of the coupons.

Different cleaners were prepared by mixing and dissolving one or more of the following ingredients in water and bringing the volume up to the desired volume with water so that the concentration for each ingredient is as desired. The ingredients were as follows: (i) Alkaline agent which is KOH or NaOH; (ii) Primary scale inhibitor; (iii) Secondary scale inhibitor; (iv) surfactant. Using the E1 formula as an example, Table 1 illustrates how the final concentrations of each ingredient are calculated if the chemicals used to prepare the composition are not 100% solid or are in the form of a stock solution.

To test the capability of different cleaner formulae in removing scale and/or preventing scale formation, 500 ml of solution was prepared for each formula. A 200 ml beaker containing 100 ml of one cleaner was placed on a stir/hot plate set at setting 200 for stirring and setting 300° C. for heating. One stir bar was placed in the beaker. When the temperature of the cleaner reached 71 C, one coupon was immersed in the cleaner inside the beaker. The coupon was placed in the beaker such that it formed an angle with the side of the 200 ml beaker. There was a space in the beaker for the stir bar to freely rotate without touching the coupon. This arrangement helped ensure that the coupon stayed stationary during the soil removal and that no mechanical force from the stir bar contributed to the scale removal from the coupon.

The coupon was incubated with the cleaner solution for 7 minutes with constant heating and stirring. During this 7-minute period, the temperature of the cleaning solution rose from 71° C. to 93° C. A series of identical coupons were prepared and each coupon was treated with one cleaner formula as described above. The same stir/hot plate was used to minimize variability in cleaning temperature, time, and agitation treatment from one coupon to the other. At the end of the test, each coupon was weighed and the difference between the weight of the coupon prior to cleaning and the weight of the coupon post-cleaning indicates the efficiency of the cleaning formula.

### Example 9

### Scale Removal Effects of the Disclosed Compositions

In order to compare the effects of scale removal of different compositions disclosed herein, various composition containing different ingredients in different amounts are subject to the Coupon Test as described in Example 8. Table 10 shows a comparison of the scale cleaning effects using KOH, in the presence or absence of ATMP, EDTA and a surfactant. The concentrations shown are all based on the calculation as explained in Examples 1 and 8. The cleaning composition containing all four ingredients (#5 in Table 10) showed the better scale removal as compared to compositions that do not contain all the individual ingredients.

TABLE 10
Comparison of the Cleaning Effects Using KOH and Different
Combinations of Other Ingredients

| | | | | | % Loss of |
|---|---|---|---|---|---|
| Study | | | | Mirataine | scale upon |
| Number | KOH % | ATMP % | EDTA % | ASC % | cleaning |
| 1 | 1.56 | | | | 42.67 |
| 2 | 1.56 | 0.031 | | | 36.90 |
| 3 | 1.56 | | 0.137 | | 47.84 |
| 4 | 1.56 | | | 0.005 | 49.95 |
| 5 | 1.56 | 0.031 | 0.137 | 0.005 | 58.13 |

Table 11 shows the result of a similar experiment comparing the cleaning effects of KOH in the presence or absence of a primary scale inhibitor such as ATMP or HEDP, a secondary inhibitor such as EDTA or HEDTA, and a surfactant (e.g., Mirataine). Duplicate solid coupons were tested. The cleaning composition having all four components, i.e., an alkaline agent, a primary inhibitor, a secondary inhibitor and the surfactant (#5 and 6 in Table 11) showed the best cleaning result.

TABLE 11
Comparison of the Cleaning Effects Using KOH and Different
Scale Inhibitors

| Study | | | | | | | % | % | | |
|---|---|---|---|---|---|---|---|---|---|---|
| Number | KOH | HEDP | HEDTA | Mirataine | ATMP | EDTA | loss A | loss B | Average | S.D. |
| 1 | 1.56 | 0 | 0 | 0 | | | 42.62 | 43.75 | 43.19 | 0.57 |
| 2 | 1.56 | 0.031 | 0 | 0 | | | 52.17 | 45.36 | 48.76 | 3.41 |
| 3 | 1.56 | | 0.137 | | | | 40.54 | 49.45 | 44.99 | 4.46 |
| 4 | 1.56 | | | 0.005 | | | 50.00 | 47.83 | 48.92 | 1.09 |
| 5 | 1.56 | 0.031 | 0.137 | 0.005 | | | 58.51 | 52.35 | 55.43 | 3.08 |
| 6 | 1.56 | | | 0.001 | 0.031 | 0.137 | 58.13 | 52.09 | 55.11 | 3.02 |

To compare the cleaning effects of cleaning compositions containing different alkaline agents, two formulae containing either KOH or NaOH were tested. As shown in Table 12, when used in conjunction with HEDP and HEDTA, there was no significant difference between the cleaning results of the compositions containing either KOH or NaOH.

TABLE 12
Comparison of the Cleaning Effects Using Different Alkaline
Agents Using HEDP and HEDTA as Scale Inhibitors

| | | | | | | % Loss of |
|---|---|---|---|---|---|---|
| | | | | HEDTA | Mirataine | scale upon |
| | NaOH % | KOH % | HEDP % | % | ASC % | cleaning |
| 1 | 1.11 | | 0.031 | 0.137 | 0.005 | 73.33 |
| 2 | | 1.56 | 0.031 | 0.137 | 0.005 | 71.96 |

However, as shown in Table 13, when other scale inhibitors were used, KOH consistently showed better scale removal effects than when NaOH is used as the alkaline agent.

TABLE 13
Comparison of the Cleaning Effects Using Different Alkaline
Agents in Conjunction with Different Scale Inhibitors

| | | % Soil | % Soil |
|---|---|---|---|
| | | Loss A | Loss B |
| Study | | (weaker | (stronger |
| Number | Cleaner Composition | scale) | scale) |
| 1 | KOH, ATMP, EDTA, S | 66.38 | 48.06 |
| 2 | NaOH, ATMP, EDTA, S | 59.80 | 33.93 |
| 3 | KOH, ATMP, IDSA, S | 62.55 | 48.13 |
| 4 | NaOH, ATMP, IDSA, S | 58.24 | 33.90 |
| 5 | KOH, EDTMPA, HEDTA, S | 58.49 | 45.68 |
| 6 | NaOH, EDTMPA, HEDTA, S | 54.69 | 39.00 |

The concentrations of various compositions used Table 13 are shown in Table 14.

TABLE 14
Formulations of the Compositions used in Table 13

| | |
|---|---|
| Ingredient | Study |

| (%) | 1 | 2 | 3 | 4 | 5 | 6 |
|---|---|---|---|---|---|---|
| KOH | 1.56 | | 1.56 | | 1.56 | |
| NaOH | | 1.11 | | 1.11 | | 1.11 |
| ATMP | 0.031 | 0.031 | 0.031 | 0.031 | | |
| EDTMPA | | | | | 0.031 | 0.031 |
| HEDP | | | | | | |
| EDTA | 0.137 | 0.137 | | | | |
| NTA | | | | | | |
| IDSA | | | 0.137 | 0.137 | | |
| HEDTA | | | | | 0.137 | 0.137 |
| Surfactant | 0.001 | 0.001 | 0.001 | 0.001 | 0.001 | 0.001 |

Next, different secondary scale inhibitors were tested for their scale removal effects. Table 15 shows that organic acids, such citric acid or gluconic acid, may also be used as a secondary scale inhibitor. Indeed, when used in conjunction with ATMP, the composition containing citric acid as a secondary scale inhibitor (#2 in Table 15) showed superior results as compared to the composition containing EDTA (#1 in Table 15).

TABLE 15
Comparison of the Cleaning Effects Using Different Secondary Scale
Inhibitors

| | | | | | Citric | Gluconic | % | % | | |
|---|---|---|---|---|---|---|---|---|---|---|
| Number | KOH | Mirataine | ATMP | EDTA | acid | acid | loss A | loss B | Average | S.D. |
| 1 | 1.56 | 0.001 | 0.031 | 0.137 | | | 58.13 | 52.09 | 55.11 | 3.02 |
| 2 | 1.56 | 0.005 | 0.031 | | 0.14 | | 62.72 | 64.35 | 63.54 | 0.82 |
| 3 | 1.56 | 0.005 | 0.031 | | | 0.14 | 58.62 | 47.17 | 52.89 | 5.73 |

Changes may be made in the above compositions and methods without departing from the scope hereof. It should thus be noted that the matter contained in the above description should be interpreted as illustrative and not in a limiting sense. The following claims are intended to cover all generic and specific features described herein, as well as all statements of the scope of the present methods and compositions, which, as a matter of language, might be said to fall therebetween.

What is claimed is:

1. A composition for removing scale and/or inhibiting formation thereof, comprising:
(i) an alkaline agent;
(ii) a primary scale inhibitor selected from the group consisting of phosphonic acid, salts of phosphonic acids, phosphonic acid derivatives, and combinations thereof; and
(iii) a secondary scale inhibitor selected from the group consisting of aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof,
wherein the composition is a stable concentrate having a pH greater than or equal to 11.

2. The composition of claim 1, wherein the alkaline agent is selected from the group consisting of sodium hydroxide, potassium hydroxide and ammonium hydroxide, and the concentration of said alkaline agent in said composition ranges from 30% to 60% (w/w, dry basis).

3. The composition of claim 1, wherein the concentration of said primary scale inhibitor in said composition ranges from 0.01% to 5% (w/w, dry basis).

4. The composition of claim 1, wherein the primary scale inhibitor is selected from the group consisting of aminotri(methylenephosphonic acid) (ATMP), 1-hydroxyethylidine-1,1-diphosphonic acid (HEDP), hexamethylenediamine tetra(methylenephosphonic acid), 2-hydroxyethyliminobis(methylenephosphonic acid), bis(hexamethylene)triamine(pentamethylenephosphonic acid), diethylenetriaminepenta(methylenephosphonic acid), ethylenediamine tetra(methylenephosphonic acid) (EDTMPA), phosphorus acid and salts thereof.

5. The composition of claim 1, wherein the concentration of said secondary scale inhibitor in said composition ranges from 0.01% to 5% (w/w, dry basis).

6. The composition of claim 1, wherein the secondary scale inhibitor is selected from the group consisting of ethylenediaminetetraacetic acid (EDTA), nitrilotriacetic acid (NTA), diethylenetriaminepentaacetic acid (DTPA), N-hydroxyethyl-ethylenediaminetriacetic acid (HEDTA), ethylenediamine disuccinic acid (EDDS), iminodisuccinic acid (IDS), methylglycinediacetic acid (MGDA), β-alaninediacetic acid (β-ADA), N-hydroxyethyliminodiacetic acid, ethylenedioxydiethylenedinitrilotetraacetic acid, ethylene glycol-bis(2-aminoethyl)-N,N,N′,N′-tetraacetic acid (EGTA), triethanolamine (TEA), ferrioxamines, N,N-bis(carboxylatomethyl)-L-glutamic acid, citric acid, gluconic acid, glycolic acid, salicylic acid, malic acid, malonic acid, fumaric acid, oxaloacetic acid, alpha-ketoglutaric acid, histidine, alanine, glycine, phenylalanine, tryptophan, serine, leucine, lysine, valine, threonine, isoleucine, methionine, arginine, cysteine, glutamine, tyrosine and salts thereof.

7. The composition of claim 1, further comprising an a surfactant, and the concentration of said surfactant in said composition ranges from 0.001% to 5% (w/w, dry basis).

8. A composition for removing scale and/or inhibiting formation thereof, comprising:
(i) an alkaline agent;
(ii) a primary scale inhibitor selected from the group consisting of phosphonic acid, salts of phosphonic acids, phosphonic acid derivatives, and combinations thereof; and
(iii) a secondary scale inhibitor selected from the group consisting of aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof,
wherein the composition is a use solution having a pH greater than or equal to 11.

9. The composition of claim 8, wherein the alkaline agent is selected from the group consisting of sodium hydroxide, potassium hydroxide and ammonium hydroxide, and wherein the concentration of said alkaline agent in said composition ranges from 0.1% to 5% (w/w, dry basis).

10. The composition of claim 8, wherein the concentration of said primary scale inhibitor in said composition ranges from 0.01% to 0.5% (w/w, dry basis).

11. The composition of claim 8, wherein the primary scale inhibitor is selected from the group consisting of aminotri(methylenephosphonic acid) (ATMP), 1-hydroxyethylidine-1,1-diphosphonic acid (HEDP), hexamethylenediamine tetra(methylenephosphonic acid), 2-hydroxyethyliminobis(methylenephosphonic acid), bis(hexamethylene)triamine(pentamethylenephosphonic acid), diethylenetriaminepenta(methylenephosphonic acid), ethylenediamine tetra(methylenephosphonic acid) (EDTMPA), phosphorus acid and salts thereof.

12. The composition of claim 8, wherein the concentration of said secondary scale inhibitor in said composition ranges from 0.01% to 0.5% (w/w, dry basis).

13. The composition of claim 8, wherein the secondary scale inhibitor is selected from the group consisting of ethylenediaminetetraacetic acid (EDTA), nitrilotriacetic acid (NTA), diethylenetriaminepentaacetic acid (DTPA), N-hydroxyethyl-ethylenediaminetriacetic acid (HEDTA), ethylenediamine disuccinic acid (EDDS), iminodisuccinic acid (IDS), methylglycinediacetic acid (MGDA), β-alaninediacetic acid (β-ADA), N-hydroxyethyliminodiacetic acid, ethylenedioxydiethylenedinitrilotetraacetic acid, ethylene glycol-bis(2-aminoethyl)-N,N,N′,N′-tetraacetic acid (EGTA), triethanolamine (TEA), ferrioxamines, N,N-bis(carboxylatomethyl)-L-glutamic acid, citric acid, gluconic acid, glycolic acid, salicylic acid, malic acid, malonic acid, fumaric acid, oxaloacetic acid, alpha-ketoglutaric acid, histidine, alanine, glycine, phenylalanine, tryptophan, serine, leucine, lysine, valine, threonine, isoleucine, methionine, arginine, cysteine, glutamine, tyrosine and salts thereof.

14. The composition of claim 8, wherein the secondary scale inhibitor is ethylenediaminetetraacetic acid (EDTA) or salts thereof.

15. The composition of claim 8, wherein the pH of the composition is greater than or equal to 12.

16. The composition of claim 8, further comprising an alkylether hydroxypropyl sultaine surfactant.

17. A composition for removing scale and/or inhibiting formation thereof, comprising:
(i) an alkaline agent selected from the group consisting of sodium hydroxide, potassium hydroxide and ammonium hydroxide;
(ii) a primary scale inhibitor selected from the group consisting of aminotri(methylenephosphonic acid) (ATMP), 1-hydroxyethylidine-1,1-diphosphonic acid (HEDP) and salts thereof; and
(iii) a secondary scale inhibitor selected from the group consisting of ethylenediaminetetraacetic acid (EDTA), N-hydroxyethyl-ethylenediaminetriacetic acid (HEDTA) and salts thereof;
wherein the composition has a pH greater than or equal to 11.

18. A method for removing scale from and/or inhibiting formation of scale on an article, comprising the steps of:
(a) providing a stable concentrate, said stable concentrate comprising
(i) an alkaline agent;
(ii) a primary scale inhibitor selected from the group consisting of phosphonic acid, salts of phosphonic acids, phosphonic acid derivatives, and combinations thereof; and
(iii) a secondary scale inhibitor selected from the group consisting of aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof;
wherein the stable concentrate has a pH greater than or equal to 11;
(b) diluting the stable concentrate to make a use solution; and
(c) contacting the use solution with said article.

19. The method of claim 18, wherein the alkaline agent is selected from the group consisting of sodium hydroxide, potassium hydroxide and ammonium hydroxide, and the concentration of said alkaline agent in said stable concentrate ranges from 30% to 60% (w/w, dry basis).

20. The method of claim 18, wherein the concentration of said primary scale inhibitor in said stable concentrate ranges from 0.01% to 5% (w/w, dry basis).

21. The method of claim 18, wherein the primary scale inhibitor is selected from the group consisting of aminotri(methylenephosphonic acid) (ATMP), 1-hydroxyethylidine-1,1-diphosphonic acid (HEDP), hexamethylenediamine tetra(methylenephosphonic acid), 2-hydroxyethyliminobis(methylenephosphonic acid), bis(hexamethylene)triamine(pentamethylenephosphonic acid), diethylenetriaminepenta(methylenephosphonic acid), ethylenediamine tetra(methylenephosphonic acid) (EDTMPA), phosphorus acid and salts thereof.

22. The method of claim 18, wherein the concentration of said secondary scale inhibitor in said stable concentrate ranges from 0.01% to 5% (w/w, dry basis).

23. The method of claim 18, wherein the secondary scale inhibitor is selected from the group consisting of ethylenediaminetetraacetic acid (EDTA), nitrilotriacetic acid (NTA), diethylenetriaminepentaacetic acid (DTPA), N-hydroxyethyl-ethylenediaminetriacetic acid (HEDTA), ethylenediamine disuccinic acid (EDDS), iminodisuccinic acid (IDS), methylglycinediacetic acid (MGDA), β-alaninediacetic acid (β-ADA), N-hydroxyethyliminodiacetic acid, ethylenedioxydiethylenedinitrilotetraacetic acid, ethylene glycol-bis(2-aminoethyl)-N,N,N′,N′-tetraacetic acid (EGTA), triethanolamine (TEA), ferrioxamines, N,N-bis(carboxylatomethyl)-L-glutamic acid, citric acid, gluconic acid, glycolic acid, salicylic acid, malic acid, malonic acid, fumaric acid, oxaloacetic acid, alpha-ketoglutaric acid, histidine, alanine, glycine, phenylalanine, tryptophan, serine, leucine, lysine, valine, threonine, isoleucine, methionine, arginine, cysteine, glutamine, tyrosine and salts thereof.

24. A method for removing scale from and/or inhibiting formation of scale on an article, comprising the steps of:
(a) providing a use solution, said use solution comprising
(i) an alkaline agent;
(ii) a primary scale inhibitor selected from the group consisting of phosphonic acid, salts of phosphonic acids, phosphonic acid derivatives, and combinations thereof; and
(iii) a secondary scale inhibitor selected from the group consisting of aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof;
wherein the use solution has a pH greater than or equal to 11; and
(b) contacting the use solution with said article.

25. The method of claim 24, wherein the article has scale on its external or internal surface, said scale comprising at least one milk protein.

26. The method of claim 24, wherein the alkaline agent is selected from the group consisting of sodium hydroxide, potassium hydroxide and ammonium hydroxide, and wherein the concentration of said alkaline agent in the use solution ranges from 0.1% to 5% (w/w, dry basis).

27. The method of claim 24, wherein the concentration of said primary scale inhibitor in the use solution ranges from 0.01% to 0.5% (w/w, dry basis).

28. The method of claim 24, wherein the primary scale inhibitor is selected from the group consisting of aminotri(methylenephosphonic acid) (ATMP), 1-hydroxyethylidine-1,1-diphosphonic acid, hexamethylenediamine tetra(methylenephosphonie acid), 2-hydroxyethyliminobis(methylenephosphonic acid), bis(hexamethylene)triamine(pentamethylenephosphonic acid), diethylenetriaminepenta(methylenephosphonic acid), ethylenediamine tetra(methylenephosphonic acid) (EDTMPA), phosphorus acid and salts thereof.

29. The method of claim 24, wherein the concentration of the secondary scale inhibitor in the use solution ranges from 0.05% to 0.5% (w/w, dry basis).

30. The method of claim 24, wherein the secondary scale inhibitor is selected from the group consisting of ethylenediaminetetraacetic acid (EDTA), nitrilotriacetic acid (NTA), diethylenetriaminepentaacetic acid (DTPA), N-hydroxyethyl-ethylenediaminetriacetic acid (HEDTA), ethylenediamine disuccinic acid (EDDS), iminodisuccinic acid (IDS), methylglycinediacetic acid (MGDA), β-alaninediacetic acid (β-ADA), N-hydroxyethyliminodiacetic acid, ethylenedioxydiethylenedinitrilotetraacetic acid, ethylene glycol-bis(2-aminoethyl)-N,N,N′,N′-tetraacetic acid (EGTA), triethanolamine (TEA), ferrioxamines, N,N-bis(carboxylatomethyl)-L-glutamic acid, citric acid, gluconic acid, glycolic acid, salicylic acid, malic acid, malonic acid, fumaric acid, oxaloacetic acid, alpha-ketoglutaric acid, histidine, alanine, glycine, phenylalanine, tryptophan, serine, leucine, lysine, valine, threonine, isoleucine, methionine, arginine, cysteine, glutamine, tyrosine and salts thereof.

31. The method of claim 24, wherein the article is an equipment selected from the group consisting of evaporators, dryers, fermentors, high temperature/short time pasteurizers (HTST's), batch pasteurizers, ultra-high temperature units (UHT units), cheese vats, paper making equipment, boilers and warewashers.

32. The method of claim 18, wherein the use solution is prepared by diluting said stable concentrate by 5-100 folds.

33. A method for extending operating time of a system, comprising:
(a) cleaning the system with a use solution, said use solution comprising:
(i) an alkaline agent;
(ii) a primary scale inhibitor selected from the group consisting of phosphonic acid, salts of phosphonic acids, phosphonic acid derivatives, and combinations thereof; and
(iii) a secondary scale inhibitor selected from the group consisting of aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof;
wherein the use solution has a pH greater than or equal to 11;
(b) rinsing the system; and
(c) placing the system in operation.

34. The method of claim 33, wherein steps (a)-(c) are repeated at least twice without performing a step of washing the system with acid (acid wash).

35. The method of claim 33, wherein steps (a)-(c) are repeated between two and five times without performing a step of washing the system with acid (acid wash).

36. A composition for removing scale and/or inhibiting formation thereof, comprising:
an alkaline agent;
a primary scale inhibitor selected from the group consisting of phosphonic acid, salts of phosphonic acids, phosphonic acid derivatives, and combinations thereof;
a secondary scale inhibitor selected from the group consisting of aminocarboxylic acids, salts of aminocarboxylic acids, carboxylic acids, salts of carboxylic acids, polycarboxylic acids, salts of polycarboxylic acids, gluconic acids, salts of gluconic acids, steroids, tetrapyrrols, ionophores, 2,2′-bipyridine, dimercaptopropanol, ortho-phenanthroline and combinations thereof,
wherein said secondary scale inhibitor does not contain any phosphonous group, and said composition has a pH greater than or equal to 11.

37. The composition of claim 36, further comprising an alkylether hydroxypropyl sultaine surfactant.
